(19) United States
(12) Patent Application Publication
(10) Pub. No.: US 2025/0192271 A1
(43) Pub. Date: Jun. 12, 2025

(54) BATTERY PACK THERMAL EXCHANGE DEVICE WITH A FIRST COOLANT PATH AND A SECOND COOLANT PATH

(71) Applicant: Ford Global Technologies, LLC, Dearborn, MI (US)

(72) Inventors: John Peter Bilezikjian, Canton, MI (US); Derek Timothy Taylor, Waterford, MI (US); Nicholas Braeseker, Novi, MI (US); Robert Reiners, Ypsilanti, MI (US)

(21) Appl. No.: 18/677,395

(22) Filed: May 29, 2024

Related U.S. Application Data
(60) Provisional application No. 63/607,888, filed on Dec. 8, 2023.

(51) Int. Cl. H01M 10/6556; H01M 10/613; H01M 10/625; H01M 10/6568; H01M 50/342; H01M 50/367

(52) U.S. Cl. CPC H01M 10/6556; H01M 10/613; H01M 10/625; H01M 10/6568; H01M 50/367; H01M 50/3425

(57) ABSTRACT

A battery pack assembly includes a thermal exchange device positioned between a first cell stack on a first tier and a second cell stack on a second tier. The thermal exchange device includes a first coolant path and a second coolant path that is separate from the first coolant path. The thermal exchange device can additionally include a vent channel in some examples.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to a thermal management assembly having separate coolant paths.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack assembly, including: a thermal exchange device positioned between a first cell stack on a first tier and a second cell stack on a second tier, the thermal exchange device including a first coolant path and a second coolant path that is separate from the first coolant path.

In some aspects, the techniques described herein relate to a battery pack assembly, wherein the first tier is a lower tier and the second tier is an upper tier.

In some aspects, the techniques described herein relate to a battery pack assembly, wherein the thermal exchange device is an extruded thermal exchange device.

In some aspects, the techniques described herein relate to a battery pack assembly, wherein coolant communicated through the first coolant path is configured to manage thermal energy of the first cell stack, and coolant communicated through the second coolant path is configured to manage thermal energy of the second cell stack.

In some aspects, the techniques described herein relate to a battery pack assembly, wherein, within the thermal exchange device, all portions of the first coolant path are vertically below the second coolant path.

In some aspects, the techniques described herein relate to a battery pack assembly, wherein the thermal exchange device extends in a first direction past the first tier and the second tier, and in a second direction past the first tier and the second tier.

In some aspects, the techniques described herein relate to a battery pack assembly, wherein the thermal exchange device is a cold plate.

In some aspects, the techniques described herein relate to a battery pack assembly, wherein the first coolant path and the second coolant path are fluidly isolated from each other within the thermal exchange device.

In some aspects, the techniques described herein relate to a battery pack assembly, wherein the first cell stack includes a plurality of battery terminals that face downward, and the second cell stack includes a plurality of battery cell terminals that face upward.

In some aspects, the techniques described herein relate to a battery pack assembly, wherein the thermal exchange device includes a vent channel separate from the first coolant path and the second coolant path, the vent channel configured to communicate vent byproducts discharged from the first cell stack, the second cell stack, or both.

In some aspects, the techniques described herein relate to a battery pack assembly, further including a battery pack enclosure assembly housing the first tier of battery cells and the second tier of battery cells, wherein the thermal exchange device extends outside the battery pack enclosure assembly in a first direction past the first tier and the second tier, and in a second direction past the first tier and the second tier.

In some aspects, the techniques described herein relate to a battery pack assembly, wherein the thermal exchange device extends in the first direction and the second direction between an enclosure tray of the battery pack enclosure assembly and an enclosure cover of the battery pack enclosure assembly.

In some aspects, the techniques described herein relate to a battery pack assembly, wherein the thermal exchange device supports the second tier.

In some aspects, the techniques described herein relate to a battery pack thermal management method, including: managing thermal energy of a first cell stack using coolant communicated along a first coolant path within a thermal exchange device; and managing thermal energy of a second cell stack using coolant communicated along a second coolant path within the thermal exchange device, the first coolant path fluidly isolated from the second coolant path within the thermal exchange device.

In some aspects, the techniques described herein relate to a battery pack thermal management method, wherein the thermal exchange device is sandwiched between the first cell stack and the second cell stack.

In some aspects, the techniques described herein relate to a battery pack thermal management method, wherein the first cell stack is inverted relative to the second cell stack such that the first cell stack includes a plurality of battery terminals that face downward, and the second cell stack includes a plurality of battery cell terminals that face upward.

In some aspects, the techniques described herein relate to a battery pack thermal management method, wherein the coolant is a liquid coolant.

In some aspects, the techniques described herein relate to a battery pack thermal management method, wherein, within the thermal exchange device, all portions of the first coolant path are vertically below the second coolant path.

In some aspects, the techniques described herein relate to a battery pack thermal management method, wherein the first cell stack is a lower tier cell stack and the second cell stack is an upper tier cell stack.

In some aspects, the techniques described herein relate to a battery pack thermal management method, further including supporting the upper tier cell stack with the thermal exchange device.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a side view of the battery pack of FIG. 1 according to an exemplary aspect of the present disclosure.

FIG. 3 illustrates the side view of FIG. 2 with an enclosure assembly of the battery pack expanded to show cell stacks of the battery pack.

FIG. 4 illustrates a perspective view of a battery cell from one of the cell stacks shown in FIG. 3.

FIG. 5 illustrates a perspective view of a thermal exchange device from the battery pack of FIGS. 2 and 3.

FIG. 6 illustrates an end view of the thermal exchange device from the battery pack of FIGS. 2 and 3.

FIG. 7 illustrates a section view taken at line 7-7 in FIG. 6.

### DETAILED DESCRIPTION

This disclosure details exemplary assemblies and methods utilized to manage thermal energy within a battery pack. The assemblies and methods involve a single thermal exchange device having a first coolant path and a second coolant path. The first and second coolant paths are separate from each other. The first coolant path can be used to manage thermal energy in a first cell stack. the second coolant path can be used to manage thermal energy in a different, second cell stack. These and other features are discussed in greater detail in the following paragraphs.

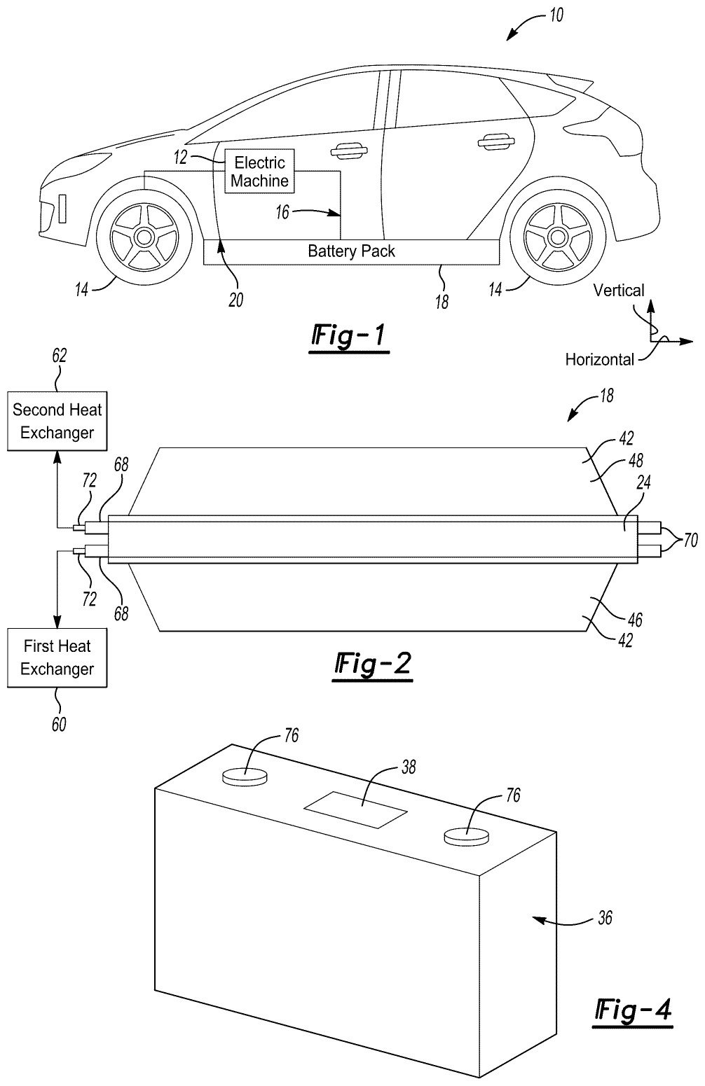

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

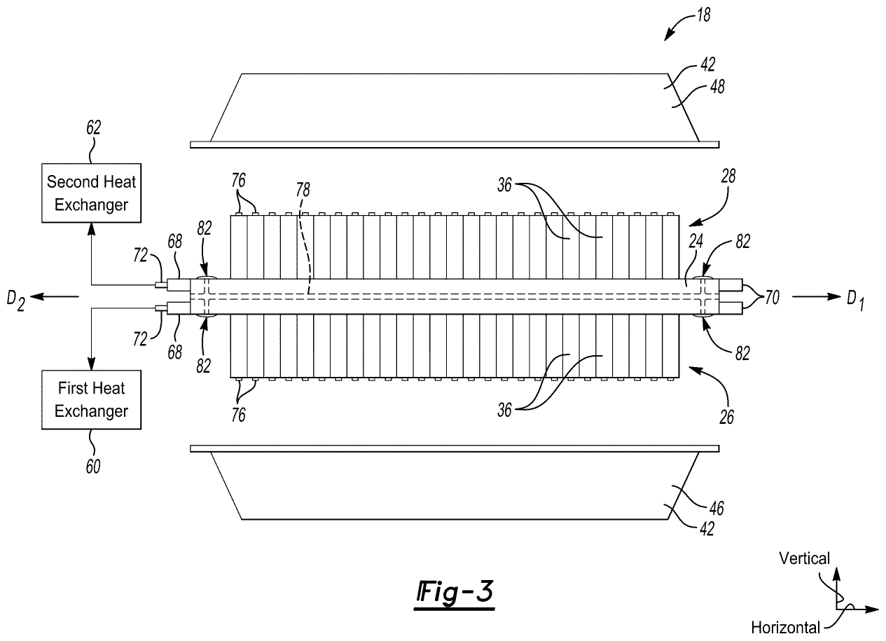

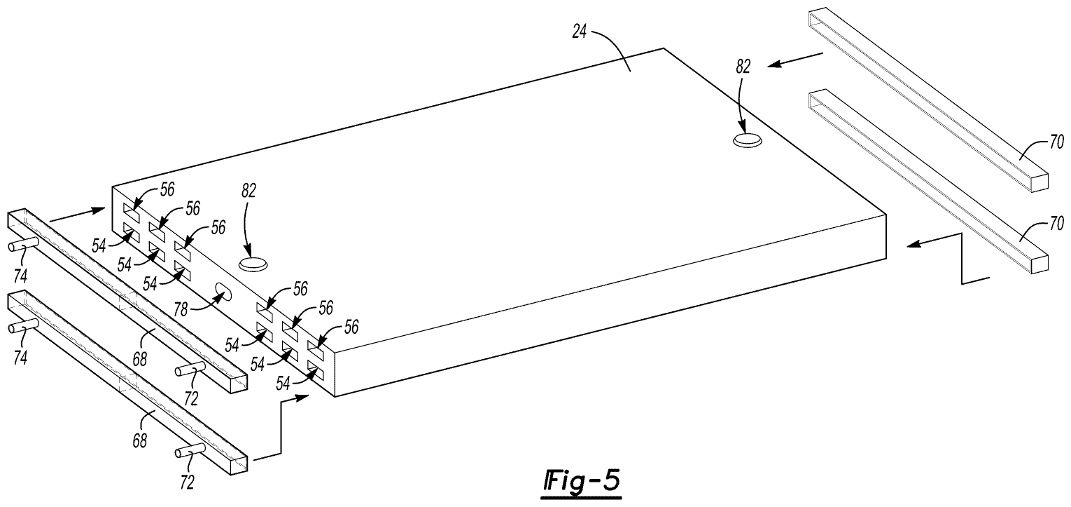

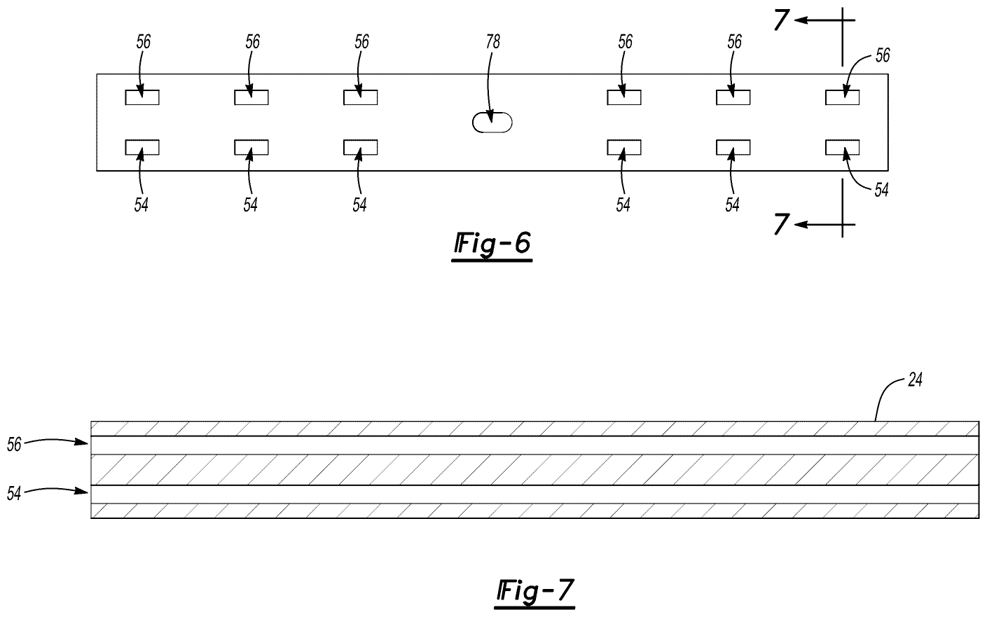

With reference to FIGS. 2-7, in an exemplary embodiment of the present disclosure, the traction battery pack 18 includes a thermal exchange device 24, a first cell stack 26, and a second cell stack 28. The thermal exchange device 24 is positioned between, and sandwiched between, the first cell stack 26 and the second cell stack 28.

The first cell stack 26 is on a first, lower tier of the battery pack 18. The second cell stack 28 is on a second, upper tier of the battery pack 18. The second cell stack 28 is vertically above the first cell stack 26. Vertical and horizontal, for purposes of this disclosure, are with reference to ground and a general orientation of the electrified vehicle 10 during operation.

The first cell stack 26 and the second cell stack 28 each include a plurality of individual battery cells 36 stacked side-by-side relative to one another along a respective cell stack axis. While the example embodiment shows one first cell stack 26 and one second cell stack 28, other examples could include more than one first cell stack 26 on the lower tier and more than one second cell stack 28 on the upper tier.

In the exemplary embodiment, the battery cells 36 are lithium-ion, prismatic battery cells. However, battery cells having other geometries (cylindrical, pouch, etc.) and/or chemistries (nickel-metal hydride, lead-acid, etc.) could alternatively be utilized within the scope of this disclosure.

From time to time, pressure and thermal energy within at least one of the battery cells 36 of the battery pack 18 can increase. This can lead to the battery cell 36 discharging a flow of vent byproducts, which can include gas and debris. The vent byproducts can be discharged from the battery cell 36 through a designated cell vent 38 within a housing of the battery cell 36. The cell vent 38 can be a membrane that yields in response to increased pressure and thermal energy within the battery cell 36. The cell vent 38 can also be a ruptured area of the associated battery cell 36.

The traction battery pack 18 additionally includes a battery pack enclosure 42. In this example, the battery pack enclosure 42 includes an enclosure tray 46 secured to an enclosure cover 48. The first cell stack 26, the second cell stack 28 are held within the battery pack enclosure 42 in this example. When the battery cell 36 expels vent byproducts, the vent byproducts initially move into an interior of the battery pack enclosure 42.

The thermal exchange device 24 extends horizontally in a first direction D1 past the first cell stack 26 and the second cell stack 28. The thermal exchange device 24 extends horizontally in a second direction D2 past the first cell stack 26 and the second cell stack 28. The thermal exchange device extends in the directions D1 and D1 between the enclosure tray 46 and the enclosure cover 48. Portions of the thermal exchange device 24 are exposed outside the battery pack enclosure 42. The thermal exchange device 24, in this example, rests on the enclosure tray 46 and utilizes the enclosure tray 46 as a support.

In another example, the thermal exchange device 24 could be contained entirely within the battery pack enclosure 42 together with the first cell stack 26 and the second cell stack 28. The thermal exchange device 24, in such an example, could be supported on the first cell stack 26, on supports within the battery pack enclosure 42, or on some combination of the first cell stack 26 and supports.

The thermal exchange device 24, in this example, includes a first coolant path 54 and a second coolant path 56 that are each configured to communicate a liquid coolant through the thermal exchange device 24. The first coolant path 54 is separate from second coolant path 56. In particular, the first coolant path 54 and the second coolant path 56 are fluidly isolated from each other. That is, coolant moving through the thermal exchange device 24 along the first coolant path 54 does not enter the second coolant path 56, and coolant moving through the thermal exchange device 24 along the second coolant path 56 does not enter the first coolant path 54.

All portions of the first coolant path 54 are vertically beneath all portions of the second coolant path 56. The first coolant path 54 is configured to communicate coolant to manage thermal energy in the first cell stack 26. The second coolant path 56 is configured to communicate coolant to manage thermal energy in the second cell stack 28.

Coolant that has moved through the first coolant path 54 can pass through a first heat exchanger 60 that is outside the battery pack 18. Coolant that has moved through the second coolant path 56 can pass through a second heat exchanger 62 that is outside the battery pack 18. The first coolant path 54 and the second coolant path 56 are each part of a separate coolant circuit. This can facilitate managing thermal energy of the first cell stack 26 separately from managing thermal energy of the second cell stack 28. For example, if the first cell stack 26 experiences a buildup of thermal energy relative to the second cell stack 28, an amount of coolant routed through the first coolant path 54 can be increased, while coolant speed through the second coolant path 56 is maintained. This can cool the first cell stack 26 more quickly than if a single coolant path was relied on the manage thermal energy in both the first cell stack 26 and the second cell stack 28.

The battery pack 18, in this example, includes a manifold assembly 68 and an end cap assembly 70 secured to opposing end portions of the thermal exchange device 24. Mechanical fasteners, for example, could be used to secure the manifold assembly 68 and the end cap assembly 70 to the thermal exchange device 24.

Coolant inlets 72 of the manifold assembly 68 deliver separate flows of coolant from outside the battery pack enclosure 42 to the first coolant path 54 and the second coolant path 56. Coolant outlets 74 of the manifold assembly 68 communicate separate flows of coolant from the first coolant path 54 and the second coolant path 56 back to a position outside the battery pack enclosure 42 after the coolant has circulated through the thermal exchange device 24. The manifold assembly 68 and the end cap assembly 70 enclose ends of the first coolant path 54 and the second coolant path 56 and route and redirect the coolant through the thermal exchange device.

The battery cells 36 of the first cell stack 26 and the second cell stack 28 each include terminals 76. To facilitate thermal management, the first cell stack 26 and the second cell stack 28 can be oriented such that terminals 76 face away from the thermal exchange device 24 so that sides of the battery cells 36 can interface directly with the thermal exchange device 24 without terminals 76 interfering. The first cell stack 26 is inverted relative to the second cell stack 28 in this example. The terminals 76 of the battery cells 36 in the first cell stack 26 face downward, and the terminals 76 of the second cells stack 26 face upward.

In addition to the first coolant path 54 and the second coolant path 56, the example thermal exchange device 24 includes at least one vent channel 78, which is separate from the first coolant path 54 and the second coolant path 56. In this example, the vent channel 78 opens to an exterior of the battery pack 18. Within the battery pack enclosure 42, each opening to the vent channel 78 can covered by a membrane 82. During a thermal event where one or more battery cells 36 is expelling vent byproducts, the membrane 82 can rupture to permit vent byproducts to enter the vent channel 78. The vent byproducts can communicate through the vent channel to the exterior of the battery pack 18. The vent byproducts can be expelled from the battery cells 36 of the first cell stack 26, the battery cells of the second cell stack 28, or both. The vent byproducts can be discharged from within the battery cells 36 through the respective cell vent 38. The membrane 82, in another example, could be covering the opening to the vent channel 78 that opens to an exterior of the battery pack 18.

The thermal exchange device 24 can be considered a cold plate. The thermal exchange device 24 is an extruded plate in this example. In another example, the thermal exchange device 24 could be cast. A person having skill in this art would understand how to structurally distinguish a component that is extruded or cast from another component that is not extruded or cast. Thus, specifying that the thermal exchange device 24 is extruded implicates structure to the thermal exchange device 24, and structurally distinguishes the thermal exchange device 24 from other types of components that are not extruded.

In this example, the first coolant path 54, the second coolant path 56, and the vent channel 78 are each provided by channels running a length of the thermal exchange device 24.

Features of the disclosed examples include providing a thermal exchange device that can support an upper tier of battery cells, help to manage thermal energy levels in those battery cells, and, when required, guide vent byproducts. Incorporating all these features into the thermal exchange device can, among other things, reduce complexity.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a thermal exchange device positioned between a first cell stack on a first tier and a second cell stack on a second tier, the thermal exchange device including a first coolant path and a second coolant path that is separate from the first coolant path.

2. The battery pack assembly of claim 1, wherein the first tier is a lower tier and the second tier is an upper tier.

3. The battery pack assembly of claim 1, wherein the thermal exchange device is an extruded thermal exchange device.

4. The battery pack assembly of claim 1, wherein coolant communicated through the first coolant path is configured to manage thermal energy of the first cell stack, and coolant communicated through the second coolant path is configured to manage thermal energy of the second cell stack.

5. The battery pack assembly of claim 1, wherein, within the thermal exchange device, all portions of the first coolant path are vertically below the second coolant path.

6. The battery pack assembly of claim 1, wherein the thermal exchange device extends in a first direction past the first tier and the second tier, and in a second direction past the first tier and the second tier.

7. The battery pack assembly of claim 1, wherein the thermal exchange device is a cold plate.

8. The battery pack assembly of claim 1, wherein the first coolant path and the second coolant path are fluidly isolated from each other within the thermal exchange device.

9. The battery pack assembly of claim 1, wherein the first cell stack includes a plurality of battery terminals that face downward, and the second cell stack includes a plurality of battery cell terminals that face upward.

10. The battery pack assembly of claim 1, wherein the thermal exchange device includes a vent channel separate from the first coolant path and the second coolant path, the vent channel configured to communicate vent byproducts discharged from the first cell stack, the second cell stack, or both.

11. The battery pack assembly of claim 1, further comprising a battery pack enclosure assembly housing the first tier of battery cells and the second tier of battery cells, wherein the thermal exchange device extends outside the battery pack enclosure assembly in a first direction past the first tier and the second tier, and in a second direction past the first tier and the second tier.

12. The battery pack assembly of claim 11, wherein the thermal exchange device extends in the first direction and the second direction between an enclosure tray of the battery pack enclosure assembly and an enclosure cover of the battery pack enclosure assembly.

13. The battery pack assembly of claim 11, wherein the thermal exchange device supports the second tier.

14. A battery pack thermal management method, comprising:
managing thermal energy of a first cell stack using coolant communicated along a first coolant path within a thermal exchange device; and
managing thermal energy of a second cell stack using coolant communicated along a second coolant path within the thermal exchange device, the first coolant path fluidly isolated from the second coolant path within the thermal exchange device.

15. The battery pack thermal management method of claim 14, wherein the thermal exchange device is sandwiched between the first cell stack and the second cell stack.

16. The battery pack thermal management method of claim 14, wherein the first cell stack is inverted relative to the second cell stack such that the first cell stack includes a plurality of battery terminals that face downward, and the second cell stack includes a plurality of battery cell terminals that face upward.

17. The battery pack thermal management method of claim 14, wherein the coolant is a liquid coolant.

18. The battery pack thermal management method of claim 14, wherein, within the thermal exchange device, all portions of the first coolant path are vertically below the second coolant path.

19. The battery pack thermal management method of claim 14, wherein the first cell stack is a lower tier cell stack and the second cell stack is an upper tier cell stack.

20. The battery pack thermal management method of claim 19, further comprising supporting the upper tier cell stack with the thermal exchange device.
